(19) United States
(12) Patent Application Publication
(10) Pub. No.: US 2026/0151732 A1
(43) Pub. Date: Jun. 4, 2026

(54) PROCESS FOR USING FOSSIL FUEL TO PRODUCE ENERGY WITH NET ZERO CARBON EMISSIONS, CCS SYSTEM AND BLUE CARBON POWER STATION

(71) Applicant: SIGNA peng, Shanghai (CN)

(72) Inventors: Sigan PENG, Shanghai (CN); Yingchuan PENG, Shanghai (CN)

(21) Appl. No.: 19/142,666

(22) PCT Filed: Dec. 27, 2023
(86) PCT No.: PCT/CN2023/142529

§ 371 Date: Jun. 24, 2025

(30) Foreign Application Priority Data
Dec. 28, 2022 (WO) PCT/CN2022/142813
Feb. 15, 2023 (WO) PCT/CN2023/076157
Aug. 19, 2023 (WO) PCT/CN2023/113915

(51) Int. Cl. B01D 53/75; B01D 53/50; B01D 53/62; B01D 53/78

(52) U.S. Cl. CPC B01D 53/75; B01D 53/50; B01D 53/62; B01D 53/78; B01D 2252/1035; B01D 2257/302; B01D 2257/504; B01D 2258/0283

(57) ABSTRACT

The present invention provides a process for using fossil fuel to produce energy with net zero carbon emissions, a CCS system and a blue carbon power station, which are engineering technology solutions of energy transition based on nature. Only natural seawater and carbon-free electricity are used. Carbon capture of deep seawater absorption and ocean carbon storage of bicarbonate ion are performed to fossil energy facilities such as coastal power station. The entire process complies with current international conventions and environmental regulations, and is friendly to marine ecological environment. It can achieve green and low-carbon transition of fossil energy facilities such as power station using gas, oil or coal at extremely low cost, and it can also be integrated with renewable energy for mutually beneficial development. It creates necessary conditions for the utilization of marine natural carbon sink on a power station scale, which is necessary to achieve the 2050 climate goal of net zero carbon emissions.

### FIELD OF THE INVENTION

The present invention relates to a process for using fossil fuel to produce energy with net zero carbon emissions, a CCS system, and a blue carbon power station, which belong to the fields of climate energy transition technology and ocean engineering technology. Specifically, it relates to a technology of using fossil fuel to produce energy with net zero carbon emission, which is mainly based on carbon capture and storage (CCS).

### DESCRIPTION OF RELATED ART

The transition from fossil energy to clean and low-carbon form and the development of renewable energy have always been regarded as two essential means for achieving the Paris climate goal of net zero carbon emissions by 2050. It has been for a long time that significant progresses, including continuously decreasing costs and expanding scale, have been made in the field of renewable energy, but the transition from fossil energy to clean and low-carbon form has stagnated. The 2016 report by the International Energy Agency (IEA) suggests that, in order to achieve the goal of net zero carbon emissions, hundreds of commercial carbon capture and storage (CCS) power station projects, which are key technical means for the transition from fossil energy to clean and low-carbon form, are required before 2020 and thousands of them are required before 2050. However, before March 2023, there was only one case of coal-fired power generation station in the world, which was shut down in 2020 due to unaffordable costs. Regarding gas power generation station, which has greater impact on carbon emissions, none has even been reported globally. Over the past 30 years of global action to mitigate climate change, CCS solutions have failed to overcome the challenges of cost and scale.

The limiting factor in reducing costs is the affordability of energy consumption and materials consumption for carbon capture. Various carbon capture means, which have been in trials, depend heavily on artificial chemical absorbents, and the inherent defect of high material consumption and high energy consumption is difficult to be overcome. The limiting factor in mitigation scale is the available scale of carbon sinks required for carbon storage. Since the international collaborative experiments on ocean carbon storage of “molecular” carbon dioxide at the beginning of this century (2002) were suspended/terminated due to regulations and marine ecological environment issues, almost all carbon storage technology experiments heavily depended on geological (including seabed geological) carbon storage, which accounts for less than 5% of the total natural carbon sink on Earth, and depended on recycling and “utilization”, which is used as the temporary carbon storage process. There is an inherent gap between the available carbon sink scale and the scale required for achieving the climate goal of net zero carbon emissions. Moreover, the overall inherent defect of CCS is prominent. The technical step of carbon capture and the technical step of carbon storage are independent of each other, without forming a continuous CCS process, which cannot achieve end-to-end coordination and “source sink matching”. Instead, they act independently and constrain each other, resulting in further increase in the overall cost of CCS and further compression of the available carbon sink scale.

Since the Paris Agreement, the concept of “blue carbon”, which aims at utilizing ocean natural carbon sinks, has become increasingly popular. It demonstrates that massive amounts of ocean natural carbon sinks (accounting for more than 93% of the Earth's total natural carbon sinks) are required for the purpose of achieving the goal of net zero carbon emissions, in which massive amount of carbon dioxide should be reduced or emitted negatively.

However, the various technical solutions, which are proposed under the concept of “blue carbon” currently, are basically limited to the edge of the concept, i.e. the utilization of “coastal carbon sinks”. Only the biological carbon sinks of coastal vegetation such as mangroves, seagrasses, and seaweed are used to naturally absorb CO₂ from the air, and it cannot be used for carbon reduction in other occasions. The theoretical scale of coastal biogenic carbon sinks is very limited even for negative emissions application (direct air carbon capture), because the proportion of marine biotic carbon sinks in marine ecosystem carbon sinks is extremely small, and the contact area between coastal areas and air is more than two orders of magnitude smaller than the entire ocean/atmosphere interface. In addition, due to many limiting factors such as the fact that most coastal organisms are submerged in ocean water and cannot contact air, the actual available scale of carbon sink is even smaller. Obviously, “the solution of utilizing natural carbon sinks in the ocean to form the most cost-effective mitigation”, which is proposed by the IPCC, has been a technical challenge that people in this field have been eager to solve but have not successful solved.

As a targeted solution, the seawater CCS technical solution was proposed in 2016 (patent number: U.S. Pat. No. 11,045,785 B2). Based on FGD development experiences and spillover knowledge, the technical solution, in which natural carbon sinks in marine ecosystems are used for carbon dioxide emissions reduction (and negative emissions), was disclosed. Only seawater is used for scrub and carbon capture (zero addition of artificial chemicals) and ocean natural alkalinity carbon storage is used. However, regarding the urgently requirement to increase decarbonization depth and accelerate large-scale deployment speed, there is still a gap in the technology to achieving the climate goal of net zero carbon by 2050.

### SUMMARY OF THE INVENTION

The first purpose of the present invention is to overcome the shortcomings of existing carbon capture technologies and provide an extremely low-cost technical solution of deep carbon capture for using fossil energy on a power station scale.

The second purpose of the present invention is to overcome the shortcomings of existing carbon storage technologies and provide an extremely low-cost technical solution of ocean carbon storage on a power station scale, which complies with international conventions and regulations and is environmentally friendly.

The third purpose of the present invention is to overcome the shortcomings of existing carbon capture and storage (CCS) technologies and provide an extremely low-cost technical solution of entire process of carbon capture and storage on a power station scale.

The fourth purpose of the present invention is to overcome the shortcomings of existing technologies and provide a technical solution of carbon capture and storage that based on nature, wherein none of artificial chemicals is added in the entire process.

The fifth purpose of the present invention is to overcome the shortcomings of existing technologies and provide a technical solution for climate change mitigation, wherein the clean energy transition and the renewable energy are integrated and developed in a mutually beneficial way.

The overall purpose of the present invention is to overcome the shortcomings of existing technologies and provide an engineering technical solution of blue carbon power station that can be deployment accelerately, wherein carbon sinks in marine ecosystems (biotic and abiotic factors) are used on a large-scale, which creates necessary conditions for obtaining massive natural carbon sinks for the climate goal of net zero carbon emissions.

The process for using fossil fuel to produce energy with net zero carbon emissions of the present invention comprises the steps of:
1) burning fossil fuel to generate energy and flue gas;
2) performing preprocessing of cooling and/or desulfurization to the flue gas to generate after-preprocessing flue gas;
3) using seawater for decarbonization to absorb and capture carbon dioxide from the after-preprocessing flue gas to generate after-decarbonization seawater and decarbonized gas;
4) discharging the decarbonized gas into atmosphere;
5) discharging the after-decarbonization seawater into an ocean for carbon storage.

The further preferred embodiments are provided as below.

The fossil fuel is selected from one or more of natural gas, fuel oil and coal.

The energy is selected from one or more of electrical energy, thermal energy, mechanical energy and hydrogen energy.

The burning of fossil fuel is an air-assisted combustion, and the pressure of the generated carbon-containing high-temperature flue gas is normal pressure, i.e. atmospheric pressure.

In step 2), the preprocessing seawater is used to scrub the flue gas, in order to achieve the preprocessing of cooling and/or desulfurization.

The temperature of the after-preprocessing flue gas does not exceed the temperature of the seawater for decarbonization by more than 50° C., or 30° C., or 20° C., or 10° C., or 5° C.

The volume content of SO₂ in the after-preprocessing flue gas is less than 100 ppm, or 80 ppm, or 30 ppm.

The preprocessing seawater is drawn from an ocean.

The preprocessing seawater comes from the secondary utilization of process wastewater such as cooling seawater from power plant.

The existing flue gas desulfurization (FGD) process of fossil energy system is used for preprocessing.

The process further comprises a step of measuring and calculating the amount of carbon dioxide (CO₂e), which is absorbed and captured from the flue gas, through measuring and calculating the difference between the CO₂ content in the flue gas and the CO₂ content in the decarbonized gas, and the CO₂e measurement data is transmitted in real-time or periodically to a carbon accounting system.

In step 3), the area of carbon capture of seawater absorption is communicated with the atmosphere.

The process further comprises a step of providing a packing layer, and in step 3), the after-preprocessing flue gas flows through the packing layer, and the seawater for decarbonization flows downward through the packing layer due to gravitational potential energy, thereby performing carbon capture of seawater absorption.

In step 3), the scrubbing is performed above sea level, and the seawater for decarbonization is drawn from the ocean.

In step 5), the after-decarbonization seawater is mixed with neutralizing seawater to form mixed seawater before discharged into the ocean, so as to raise the pH value to meet the legal discharge standard.

The legal discharge standard refers to the discharge standard permitted under the regulations governing the discharge area, including the IMO MEPC rules under the United Nations MARPOL Convention and the pH limit in the EPA VGP rules governing North America.

The discharge standard permitted under the regulations includes the regulations on the discharge mixing zone designated by the environmental law enforcement department in the area where the discharge is performed.

In the discharging seawater that meets the legal discharge standard, the CO₂, which is absorbed and captured by the seawater, is converted into incremental bicarbonate ions (HCO₃⁻)—the natural form and main form of carbon in the ocean. In Step 5), it is discharged into the ocean to achieve ionic ocean carbon storage.

In step 5), the after-decarbonization seawater is discharged into the ocean below sea level through a discharging pipe by its own weight.

The preprocessor, decarbonization tower and discharging apparatus run at atmospheric pressure, and the water from the apparatus is discharged by its own weight and flows into the next location and/or into the ocean.

The process further comprises a step of providing a CCS ocean platform.

Any one or more steps of the preprocessing, decarbonization absorption, neutralization, and other steps are carried out on an offshore CCS ocean platform to reduce the height and energy consumption of pumping the seawater.

The seawater for decarbonization and/or neutralizing seawater are pumped in a mode of high flow and low height to reduce pumping height and energy consumption.

The pumping height of the seawater for decarbonization, that is, the height of the water distributor of the decarbonization tower relative to the actual sea level, does not exceed 50 m, 30 m, 25 m, 20 m, 15 m, 10 m, 9 m, 8 m, 7 m, 6 m, 5 m, 4 m, 3 m, 2 m, 1 m, or 0.5 m.

The neutralizing seawater is drawn from the ocean.

The pumping height of the neutralizing seawater, that is, the height of the liquid level in neutralizer relative to the actual sea level, does not exceed 10 m, 9 m, 8 m, 7 m, 6 m, 5 m, 4 m, 3 m, 2 m, 1 m, 0.5 m, or 0.2 m.

The seawater for decarbonization is drawn from a deep location in the ocean.

The depth, at which the seawater for decarbonization is drawn from the ocean, is not less than 0.5 m, or not less than 1 m, or not less than 3 m, or not less than 5 m, or not less than 10 m, or not less than 15 m, or not less than 20 m, or not less than 30 m, or not less than 50 m, or not less than 100 m, or not less than 200 m, or not less than 300 m, or not less than 500 m, or not less than 1000 m, or not less than 2000 m relative to the actual sea level.

In step 3), the ratio of the flow of seawater for decarbonization to that of flue gas is adjusted, so that the pH value of after-decarbonization seawater meet the legal discharge standard.

In step 5), the after-decarbonization seawater is mixed with neutralizing seawater to form mixed seawater before discharged into the ocean, so as to increase the pH value to meet the legal discharge standard.

The process further comprises a step of providing a carbon-free power generation system.

The seawater pumps that draws and pumps seawater for decarbonization and/or neutralizing seawater and/or preprocessing seawater from the ocean are driven by a carbon-free power generation system.

The carbon-free energy includes one or more of wind energy, solar energy, wave energy, tidal energy, and nuclear energy.

The carbon-free power generation system includes an energy storing apparatus to ensure uninterrupted power supply.

The process further comprises a step of providing a direct air carbon capture and storage (DACCS) system, and the amount of carbon dioxide, which is directly captured and stored from the atmosphere by the DACCS system, is equal to the amount of carbon dioxide in the decarbonized gas, which discharged into the atmosphere in step 4), to achieve fossil energy utilization with net zero carbon emissions as a whole.

The carbon capture and storage (CCS) system of the present invention includes:
a preprocessor, which is used to cool and/or desulfurize the flue gas of fossil fuel to generate after-preprocessing flue gas;
an decarbonization tower, which is used to scrub the after-preprocessing flue gas with seawater for decarbonization to absorb and capture carbon dioxide, generating after-decarbonization seawater and decarbonized gas, and discharge the decarbonized gas into atmosphere;
an apparatus for providing seawater for decarbonization, which is used to pump seawater from the ocean into the decarbonization tower, which is used as the seawater for decarbonization;
a discharging apparatus, which is used to discharge the after-decarbonization seawater into an ocean for carbon storage.

The further preferred embodiments are provided as below.

The fossil fuel is selected from one or more of natural gas, fuel oil, and coal.

The combustion device, which generates flue gas, includes a boiler, a combined cycle gas steam turbine (CCGT), a waste heat boiler, and an internal combustion engine.

The preprocessor is configured to scrub the flue gas with preprocessing seawater to achieve preprocessing of cooling and/or desulfurization.

The preprocessing seawater is drawn from the ocean.

The preprocessing seawater comes from the cooling seawater of the power plant.

The volume content of SO₂ in the preprocessing flue gas is less than 100 ppm, or less than 80 ppm, or less than 30 ppm.

The temperature of the after-preprocessing flue gas does not exceed the temperature of the seawater for decarbonization by more than 50° C., 30° C., 20° C., 10° C., or 5° C.

The discharging apparatus further includes a neutralizer, which is used to mix the after-decarbonization seawater with neutralizing seawater to form mixed seawater, so as to increase the pH value to meet the legal discharge standard.

The internal cavity area of the decarbonization tower, which is used for scrubbing, is communicated with the atmosphere through an exhaust pipe.

The internal pressure of the decarbonization tower is normal pressure (atmospheric pressure).

The seawater for decarbonization is introduced into the decarbonization tower from the upper part of the tower and drops downwards by its own weight to come into contact with the carbon-containing gas, which is introduced into the tower, to scrub and capture CO₂ in the gas.

The decarbonization tower is a packing tower, and the seawater for decarbonization comes into contact with the carbon-containing gas through the packing layer to obtain a larger gas-liquid contact area, thereby improving the capture effect of CO₂ of scrubbing and dissolution.

The packings are made of materials that can withstand accident-related high temperatures, including metals, ceramics, and polymer materials.

The discharging apparatus includes a discharging pipe, which is used to discharge the after-decarbonization seawater into the ocean below the sea surface by its own weight.

The preprocessor/decarbonization tower/discharging apparatus run at normal pressure (atmospheric pressure), and the water from the apparatus is discharged by its own weight and flows into the next location and/or into the ocean.

The decarbonization tower includes a water distributor, and the height of the outlet of the water distributor is not higher than 50 m, 30 m, 25 m, 20 m, 15 m, 10 m, 9 m, 8 m, 7 m, 6 m, 5 m, 4 m, 3 m, 2 m, 1 m, or 0.5 m relative to the actual sea level.

The pumping height of the neutralizing seawater, i.e. the height of the liquid level in the neutralizer relative to the actual sea level, does not exceed 10 m, 9 m, 8 m, 7 m, 6 m, 5 m, 4 m, 3 m, 2 m, 1 m, 0.5 m, or 0.2 m.

The apparatus for providing seawater for decarbonization includes a water drawing pipe for drawing seawater from the ocean below sea level. The inlet at the lower end of the water drawing pipe has a depth of not less than 0.5 m, or not less than 1 m, or not less than 3 m, or not less than 5 m, or not less than 10 m, or not less than 15 m, or not less than 20 m, or not less than 30 m, or not less than 50 m, or not less than 100 m, or not less than 200 m, or not less than 300 m, or not less than 500 m, or not less than 1000 m, or not less than 2000 m relative to the actual sea level.

The discharging apparatus further includes a discharge detecting device for detecting the pH value of seawater before discharging.

The apparatus for providing seawater for decarbonization further includes a device for adjusting the flow rate of seawater for decarbonization, so that the pH value of the after-decarbonization seawater meets the legal discharge standard.

The discharging apparatus further includes a neutralizer, which is used to mix the after-decarbonization seawater with neutralizing seawater to form mixed seawater, so as to increase the pH value to meet the legal discharge standard.

The system further includes an apparatus for providing neutralizing seawater, which is used to draw seawater from the ocean, which is used as the neutralizing seawater.

The system further includes a CCS ocean platform, wherein the preprocessor and/or decarbonization tower and/or neutralizer are located on the CCS ocean platform to reduce the height and power consumption of pumping seawater, and to reduce the land area occupied by the CCS system.

The CCS ocean platform is selected from one or more of floating ocean platform, height-adjustable ocean platform, and fixed ocean platform.

The CCS ocean platform is a floating ocean platform that rises and falls with the tides of the sea surface to reduce the additional pumping height and power consumption caused by tidal rise and fall. It is selected from one or more customized CCS floating dock and conventional ocean vessel.

The CCS floating ocean platform is a CCS floating dock floating on the sea surface, which rises and falls with the tide to overcome the power loss caused by tidal range. The connection between the floating dock and the upper part of the support frame of ocean platform, which is fixed to the seabed, is vertically slidable and horizontally limited.

The CCS floating dock is equipped with an anchoring device for limiting position, in order to limit the horizontal movement range of the ocean platform from being pushed by wind and waves.

The CCS ocean platform is a height-adjustable ocean platform that rises and falls with the tide of the sea surface to reduce the additional pumping height and power consumption caused by tidal rise and fall. It is selected from customized height-adjustable ocean platforms.

The height of the CCS height-adjustable ocean platform is adjusted through a support frame of ocean platform, which is fixed at the bottom of the seabed and equipped with hydraulic/pneumatic/mechanical devices to adjust the height. It automatically controls the rise and fall of the CCS height-adjustable ocean platform according to the tide to overcome the power loss caused by tidal range.

The CCS ocean platform is a fixed ocean platform that has a constant height relative to the seabed, which is selected from conventional ocean platforms.

The underwater part of the CCS fixed ocean platform is fixed to the seabed through a support frame, and the height of the above-water part is fixed. The height is designed based on the highest tide level. The highest tide level is based on every year, or every 5 years, or every 10 years, or every 50 years, respectively.

The preprocessor is installed on the same CCS ocean platform as the decarbonization tower or located onshore together with the fossil energy system. The carbon-free power generation device is integratedly located on the same CCS ocean platform with the CCS system, and/or located on the sea and/or shore adjacent to the CCS system.

The system further includes a floating extendable flue for transporting the flue gas from onshore fossil energy systems to CCS ocean platform.

The system further includes an apparatus for measuring amount of carbon capture and storage, i.e. the amount of the carbon dioxide (CO₂e) captured and stored from flue gas, and generating measurement data, and transmitting the measurement data in real-time or periodically to a carbon accounting system.

The apparatus for measuring amount of carbon capture and storage is configured to detect the amount of carbon dioxide, which is contained in the flue gas of fossil fuel before contact with the seawater for decarbonization, and the amount of carbon dioxide, which is contained in decarbonized gas after contact with the seawater for decarbonization, thereby achieving the measurement of the amount of carbon dioxide (CO₂e), which is captured and stored in flue gas of fossil fuel.

The system further includes a carbon-free power generation system.

The carbon-free power generation system drives seawater pumps to draw and pump the seawater for decarbonization and/or neutralizing seawater and/or preprocessing seawater from the ocean.

The carbon-free power generation system uses one or more of wind energy, solar energy, wave energy, tidal energy, and nuclear energy. The carbon-free power generation system includes an energy storing device to ensure uninterrupted power supply.

The system further includes a direct air carbon capture and storage (DACCS) system.

The blue carbon power station of the present invention comprises a fossil energy system for burning fossil fuel to generate electricity and flue gas, wherein the blue carbon power station further comprises a CCS (carbon capture and storage) system of the present invention, which is used to decarbonize the flue gas.

The further preferred embodiments are provided as below.

The fossil energy system is selected from one or more of coal-fired boiler steam turbine power generation system, gas turbine power generation system, and combined cycle gas steam (CCGT) power generation system.

The blue carbon power station further includes a flue gas bypass system, which is used to guide flue gas to the atmosphere, isolate the risk of maritime accidents and ensure the safe running of onshore fossil energy systems when a risk accident occurs in the offshore carbon capture and storage system.

The flue gas bypass system includes a flue gas bypass gate and a flue gas bypass exhaust pipe. The flue gas bypass gate is configured to guide the flue gas to the flue gas bypass exhaust pipe and thus to the atmosphere when a risk accident occurs in the carbon capture and storage system.

The CCS system further comprises a fixed ocean platform, wherein the preprocessor is located onshore, and the decarbonization tower and neutralizer are located on the fixed ocean platform. At least 70% of carbon dioxide in the flue gas of fossil fuel is captured and stored.

The CCS system further comprises a height-adjustable ocean platform, wherein the preprocessor, decarbonization tower and neutralizer are located on the height-adjustable ocean platform. The preprocessor is configured to scrub the flue gas fossil fuel with preprocessing seawater to achieve preprocessing of cooling and/or desulfurization. The preprocessing seawater, seawater for decarbonization and neutralizing seawater are drawn from the ocean, and the energy required for pumping is provided by the power station itself. At least 80% of carbon dioxide in the flue gas of fossil fuel is captured and stored.

The CCS system further includes a floating ocean platform and a carbon-free power generation system. The preprocessor, decarbonization tower and neutralizer are located on the CCS ocean platform. The preprocessor is configured to scrub the flue gas of fossil fuel with preprocessing seawater to achieve preprocessing of cooling and/or desulfurization. The preprocessing seawater, seawater for decarbonization and neutralizing seawater are drawn from the ocean, and the energy required for pumping seawater is provided by a carbon-free power generation system and/or the power station itself. At least 90% of carbon dioxide in the flue gas of fossil fuel is captured and stored.

The CCS system further comprises a floating ocean platform, a carbon-free power generation system and a direct air carbon capture and storage (DACCS) system. The preprocessor, the decarbonization tower and the neutralizer are located on the CCS ocean platform. The CCS ocean platform is a floating and/or height-adjustable ocean platform that can rise and fall with the tide. The preprocessing seawater, the seawater for decarbonization and the neutralizing seawater are drawn from the ocean and the energy for pumping seawater is provided by a carbon-free power generation system mainly. At least 95%, or 90%, or 85%, or 80%, or 75%, or 70%, or 60%, or 50% of carbon dioxide in the flue gas of fossil fuel is captured and stored. The direct air carbon capture and storage (DACCS) system is used to directly capture and store carbon dioxide from the atmosphere, and the amount of carbon dioxide, which is captured and stored, is equal to the amount of carbon dioxide in the decarbonized gas, which is discharged into the atmosphere. The required electrical energy is provided by the carbon-free power generation system.

The clean energy product produced by the fossil energy converting system is transmitted to the outside. The energy product includes but is not limited to electrical energy and/or thermal energy and/or mechanical energy and/or hydrogen energy.

The carbon-free power generation system transmits the carbon-free energy product to the outside through a channel for outputting carbon-free energy product. The energy product includes but is not limited to electrical energy and/or thermal energy and/or mechanical energy and/or hydrogen energy and/or other energy products.

The technical principle and effects of the present invention are described as follows.

In the technical solution of the present invention, only seawater is used to absorb and capture CO₂, which is converted into bicarbonate ions (HCO₃⁻)—the natural form of carbon in seawater, and is permanently stored in the ocean. The principles of seawater absorption and carbon capture and the principles of ocean carbon storage in bicarbonate ion mode are based on the following marine chemical reaction equations.

The chemical reaction formula for CO₂ dissolution in seawater is:

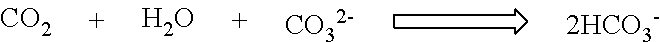

Firstly, the principles of marine chemistry tell us that in the normal pH range of 7.8˜8.3 of seawater and in the pH range of 6˜9 required by marine environmental regulations, the above chemical reaction proceeds in the right direction, producing bicarbonate ions (HCO₃⁻)—the natural form and main form of carbon in seawater. The technical solution of the present invention is designed according to the legal discharge standard on the specific implementation area. For example, the pH limit of pH ≥6.5, which is regulated in the IMO MEPC 259 (68) rule under the United Nations MARPOL Convention, or the pH limit of pH ≥6.0, which is regulated in the EPA VGP 2013 rule governing North America, is used as the pH limit for the discharge of after-decarbonization seawater in the present invention. Therefore, what actually enters in and is stored in seawater is the bicarbonate ions (HCO₃⁻) of natural form. That is to say, the “Ocean Storage of HCO₃⁻” is performed in the present invention, which is different from the “Ocean Storage of CO₂” that is questioned by the public and restricted by regulations. Moreover, the technical solution of the present invention not only has legal basis, but also has the technical effects of the climate and environment of marine ecological environment friendliness and permanent marine carbon storage.

Secondly, the rate and amount of CO₂ dissolution in seawater are negatively correlated and highly sensitive to the temperature and acidity of the seawater. The lower the temperature and acidity of seawater are, the higher the rate of CO₂ dissolution is, and the more the amount of CO₂ dissolution is, and the higher the corresponding carbon capture rate is, and the deeper the decarbonization is. Therefore, in another aspect of the technical solution of the present invention, seawater is used to scrub the high-temperature high-sulfur flue gas generated by fossil fuel combustion in a preprocessing mode, and to transform it into low-temperature low-sulfur gas, significantly reducing the temperature and acidity aroused by the flue gas to the seawater for decarbonization. On the other hand, fresh seawater with lower water temperature (at least 8-9° C. lower than the cooling water temperature of the power station) is drawn from the ocean as the seawater for decarbonization, so that the temperature and acidity of the seawater, which is used for scrubbing, dissolving, and capturing CO₂ in the decarbonization tower, are lower, achieving the technical effect of further improving carbon capture rate and increasing decarbonization depth.

Furthermore, in the present invention, the seawater for decarbonization is used to scrub flue gas and capture CO₂, and the amount of carbon captured is positively correlated with the flow rate of the seawater for decarbonization. Therefore, the maximum value of the capture amount and the decarbonization depth depends on the affordable total energy consumption of seawater for decarbonization. This energy consumption is equal to the result of the total flow amount of seawater for decarbonization multiplied by the pumping height of seawater. Therefore, in the present invention, a high flow amount and a low pumping height are adopted, and the decarbonization tower and other apparatuses, in which a large amount of water is needed, are arranged on a CCS ocean platform as close to the sea surface as possible, which significantly reduces the pumping height and power consumption required for pumping seawater compared to being arranged in the onshore power station area. In addition, the CCS floating ocean platform rises and falls with the tide, and the pumping height of seawater can always be at the optimal value, eliminating the additional energy loss caused by the configuration that a distance should be set for tide drop (generally several meters to more than ten meters). Therefore, it achieves a significant technical effect of reducing decarbonization costs. Furthermore, it also solves the problem that existing power stations lack land space to build CCS system.

Furthermore, in the present invention, the seawater for decarbonization of is drawn from a deep location in the ocean, aiming to obtain a higher carbon capture rate by using seawater for decarbonization with lower temperature from a deeper location. For example, in some ocean areas, the seawater temperature decreases by about 0.5° C. per 100 m depth. Based on the principle that there is no need for extra potential energy when the medium is vertically pumped in a homogeneous and same-phase (fluid) environment, it has little impact on the power consumption of the water pump, i.e. the cost, to increase depth where the water is drawn, but it greatly helps to improve the CO₂ solubility and carbon capture rate.

The overall technical effect of the technical solution of the present invention is to achieve green and low-carbon transition of fossil fuel facilities such as gas-fired or coal-fired power station at extremely low cost, and to integrate the renewable energy for mutually beneficial development, creating necessary conditions for utilization of marine natural carbon sink on a power station scale, which is necessary to achieve the 2050 climate goal of net zero carbon emissions.

### BRIEF DESCRIPTION OF THE DRAWINGS

FIG. 1 is a schematic diagram showing an example of the process for using fossil fuel to produce energy with net zero carbon emissions in the present invention.

FIG. 2 is a schematic diagram showing an example of the system for producing energy with low carbon emissions in a coal-fired power station in the present invention, characterized in that the preprocessor is located onshore, and the decarbonization tower and neutralizer are located offshore, and the electricity of power station is used to drive CCS seawater pump.

FIG. 3 is a schematic diagram showing an example of the system for producing energy with low carbon emissions in a combined cycle gas steam power station in the present invention, characterized in that the preprocessor, the decarbonization tower and neutralizer are located on a floating CCS ocean platform, and the electricity of power station is used to drive CCS seawater pump.

FIG. 4 is a schematic diagram showing an example of the system for producing energy with near zero carbon emissions in a combined cycle gas steam power station in the present invention, characterized in that the preprocessor, the decarbonization tower and neutralizer are located on a floating CCS ocean platform, and carbon-free energy is used to drive CCS seawater pump.

FIG. 5 is a schematic diagram showing an example of the system for producing energy with net zero carbon emissions in a fossil fuel power station in the present invention, characterized in that the preprocessor, the decarbonization tower and neutralizer are located on a floating CCS ocean platform, and carbon-free energy is used to drive CCS seawater pump and a direct air carbon capture and storage (DACCS) system.

FIG. 6 is a schematic diagram showing the structure of the decarbonization tower, the height of the water distributor and the height of the liquid level in the neutralizer.

Names of components or structures corresponding to the reference numbers in the drawings are provided as follows.

1—fossil energy system, 1.1—combustion device, 1.2—flue gas exhaust duct, 1.3—flue gas bypass gate, 1.4—flue gas bypass exhaust pipe, 1.5—fossil energy converting device, 1.6—fossil energy power generation device, 1.7—channel for outputting clean energy product, 2—CCS system, 2.1—CCS ocean platform, 2.1—1—CCS fixed ocean platform, 2.1—2—CCS height-adjustable ocean platform, 2.1—3—CCS floating ocean platform (floating dock), 2.2—offshore flue and support, 2.3—preprocessor, 2.4—preprocessing seawater pump, 2.5—water drawing pipe of preprocessing seawater pump, 2.6—pipe for delivering preprocessing seawater, 2.7—pipe for discharging preprocessing seawater which meets the standard, 2.8—processing pool of preprocessing seawater, 2.9—packing layer, 2.10—water distributor, 2.11—height of water distributor, 2.12—decarbonization tower, 2.13—pump of seawater for decarbonization, 2.14—water drawing pipe of seawater for decarbonization pump, 2.15—support frame of ocean platform, 2.16—pipe for delivering seawater for decarbonization, 2.17—water discharging pipe of decarbonization tower, 2.18—neutralizer, 2.19—neutralizing seawater pump, 2.20—water drawing pipe of neutralizing seawater pump, 2.21—height of liquid level in neutralizer, 2.22—neutralizing seawater pipe, 2.23—pH detecting controller, 2.24—decarbonized flue gas pipe, 2.25—exhaust pipe, 2.26—pipe for discharging seawater which meets the standard, 3—CO₂e metering unit/device, 3.1—CO₂e data channel, 3.2—CCS sampling data channel, 4—carbon-free power generation system, 4.1—wind power station, 4.2—wind turbine, 4.3—energy storing device, 4.4—power line, 4.5—photovoltaic power station, 4.6—wave energy generator, 4.7—channel for outputting carbon-free energy product, 5—direct air carbon capture and storage (DACCS) system.

### DETAILED DESCRIPTION OF THE PREFERRED EMBODIMENTS

### Example 1

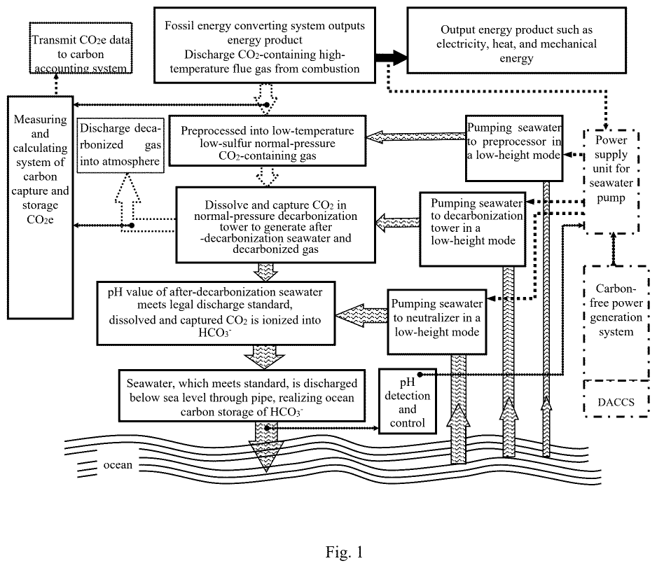

This is a basic example of the process for using fossil fuel to produce energy with net zero carbon emissions of the present invention, as shown in FIG. 1. The process comprises the steps of:
1) burning fossil fuel to generate energy and flue gas;
2) performing preprocessing of cooling and/or desulfurization to the flue gas to generate after-preprocessing flue gas;
3) using seawater for decarbonization to absorb and capture carbon dioxide from the after-preprocessing flue gas to generate after-decarbonization seawater and decarbonized gas;
4) discharging the decarbonized gas into atmosphere;
5) discharging the after-decarbonization seawater into an ocean for carbon storage.

### Example 2

This is an example based on Example 1, comprising the steps of:
1) burning fossil fuels to generate energy and high-temperature carbon(CO₂)-containing flue gas; and performing preprocessing of cooling and/or desulphurization to the high-temperature flue gas into low-temperature low-sulfur carbon(CO₂)-containing gas, and then introducing it into a decarbonization tower;
2) using a seawater pump to draw seawater for decarbonization from an ocean and introducing it into the decarbonization tower to scrub the carbon-containing gas to capture CO₂ in the carbon-containing gas, generating decarbonized gas and after-decarbonization seawater; and discharging the decarbonized gas into the atmosphere;
3) adjusting the pH value of the after-decarbonization seawater to meet the regulatory discharge standard to generate discharging seawater which meets the standard, wherein the CO₂, which is dissolved and captured in the seawater after decarbonization absorption, is converted into incremental bicarbonate ions (HCO₃⁻);
4) the discharging seawater which meets the standard is discharged into the ocean below the sea level through a pipe by its own weight to achieve ocean carbon storage of bicarbonate ion;
5) measuring and calculating the amount of carbon dioxide (CO₂e) captured and stored in the ocean.

The step of pumping the seawater for decarbonization and/or neutralizing seawater from the ocean is carried out in a mode of high flow and low height, and the required electrical energy comes from fossil fuels and/or carbon-free energy sources.

The seawater for decarbonization is drawn from a deep location in the ocean.

The fossil fuels include natural gas, or oil, or coal.

The clean energy products produced by the fossil energy converting system are transmitted to an outside, including but not being limited to electrical energy and/or thermal energy and/or mechanical energy and/or hydrogen energy.

### Example 3

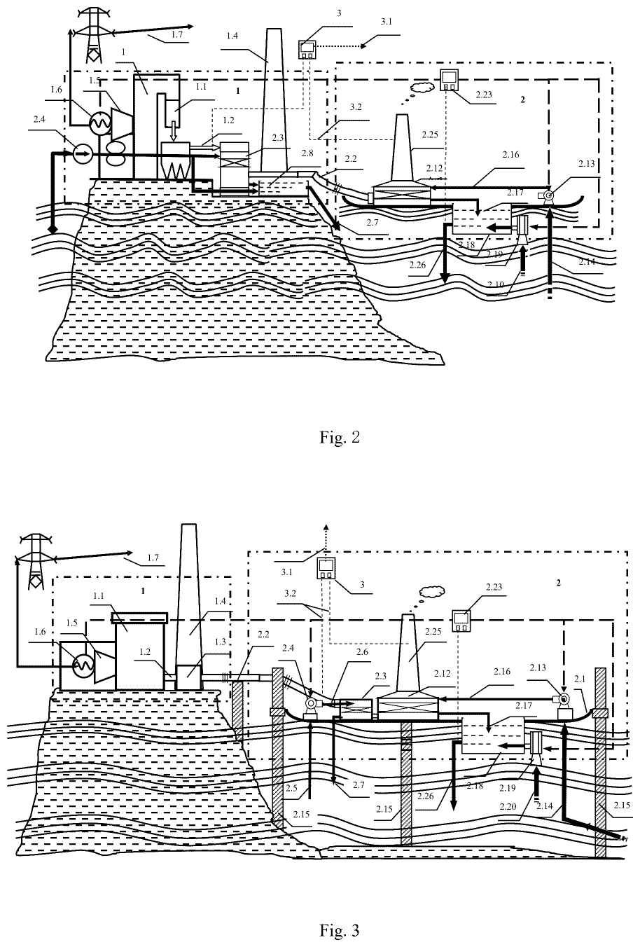

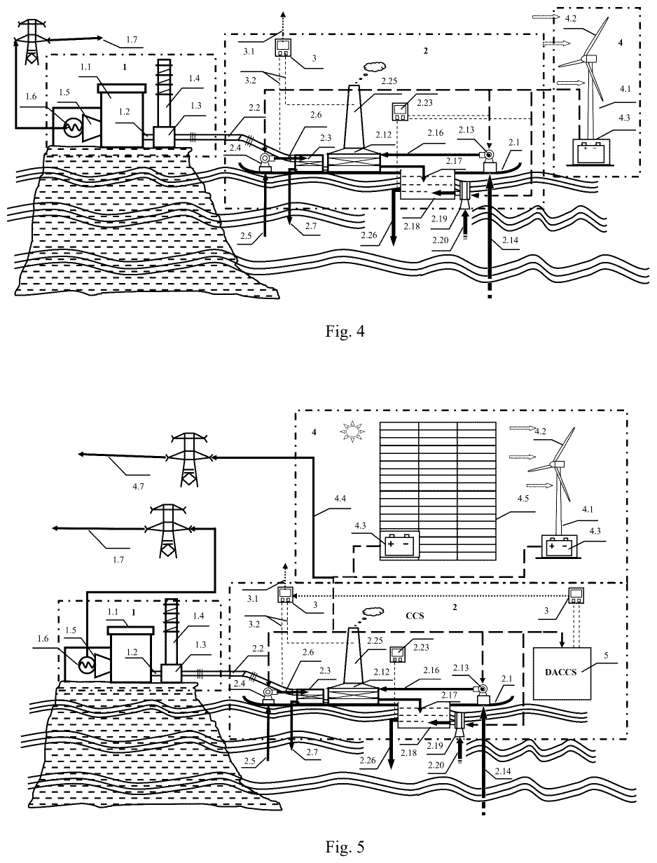

These are multiple groups of examples based on Example 1, as shown in FIG. 1-FIG. 6.

The combustion of fossil fuel is air combustion, and the pressure of the generated carbon-containing high-temperature flue gas is normal pressure, i.e. atmospheric pressure. In one example, scrubbing seawater for preprocessing is used to scrub the carbon(CO₂)-containing high-temperature flue gas for cooling and/or desulfurization. In another example, the existing flue gas desulfurization (FGD) process of fossil energy system is used for preprocessing. In one example, the scrubbing seawater for preprocessing is drawn from the ocean; and in another example, process wastewater such as cooling seawater from a power station is used as the scrubbing seawater for preprocessing. The temperature of the cooling seawater of the power station is generally 8-9° C. higher than that of seawater directly drawn from the ocean. Therefore, the cooling and/or desulfurization effect of the scrubbing seawater for preprocessing directly drawn from the ocean is better, which is helpful to improve the decarbonization absorption effect and carbon capture rate.

Regarding the temperature and sulfur-containing parameters of the low-temperature low-sulfur carbon-containing gas before decarbonization absorption, the temperature of the carbon-containing gas is not higher than 50° C., or not higher than 30° C., or not higher than 20° C., or not higher than 10° C., or not higher than 5° C. compared to the water temperature of the seawater for decarbonization in a group of examples, and the volume content of SO₂ in the carbon containing-gas is less than 100 ppm, or less than 80 ppm, or less than 30 ppm in another group of examples. The temperature and sulfur-containing parameters of the low-temperature low-sulfur carbon-containing gas, which is generated before decarbonization absorption and after preprocessing, is adjusted through adjusting the flow rate of the scrubbing seawater for preprocessing.

The internal pressure of the decarbonization tower is normal pressure (atmospheric pressure) and is communicated with the external atmosphere through an exhaust pipe. The seawater for decarbonization is introduced into the decarbonization tower from the upper part of the tower and drops downwards by its own weight to make contact with the carbon-containing gas, which is introduced into the tower, thereby scrubbing and capturing CO₂.

In one example, a packed absorbing tower is used, and the seawater for decarbonization makes contact with the carbon-containing gas through a packing layer to achieve larger gas-liquid contact area and better capture effect of scrubbing and dissolving CO₂.

In the step of adjusting the pH value of after-decarbonization seawater to meet regulatory discharge standard, the standard is the regulatory discharge standard of the jurisdiction district where the discharge is performed, such as the regulation of the pH ≥6.5 in the IMO MEPC 259 (68) rule under the United Nations MARPOL Convention, or the pH ≥6.0 in the EPA VGP 2013 rule governing North America, including specific regulation for discharge mixing zone designated by local environmental law enforcement agency. On these conditions, the CO₂, which is scrubbed and captured in the discharging seawater meeting the discharge standard, has been converted into incremental bicarbonate ions (HCO₃⁻), which is the natural and primary form of carbon in the ocean. The step of discharging it into the ocean below the sea surface is to achieve natural and permanent ocean carbon storage of bicarbonate ion (HCO₃⁻).

In the step of adjusting the pH value, the ratio of the flow rate of seawater for decarbonization to the flow rate of carbon-containing gas is adjusted, and/or the seawater for decarbonization is mixed with the neutralizing seawater in a neutralizer and the mixing ratio is adjusted. For this purpose, in one example, a pH detecting controller is installed in the power supplying control circuit, which is used for the pump of seawater for decarbonization and the neutralizing seawater pump. The neutralizing seawater is drawn from the ocean.

In the step of measuring and calculating the amount of carbon dioxide (CO₂e) which is captured and stored in the ocean, the difference of CO₂ content between 1) the carbon-containing high-temperature flue gas discharged from the combustion of fossil fuel and 2) the decarbonized gas discharged from the decarbonization tower, and the calculated data of CO₂e (amount of CO₂) is transmitted to a designated carbon accounting system.

The technology for measuring and calculating the CO₂ content in gas is relatively developed, and related CO₂e meters and data processors can be selected from commercially available instruments for measuring flue gas composition.

In the step of pumping in a mode of high flow rate and low height, the pumping height of the seawater, which is needed by the decarbonization tower 2.12, the neutralizer 2.18 and the preprocessor 2.3, is reduced to reduce potential energy loss. Both lowering the foundation elevation of the device to sea level to reduce foundation potential energy loss and lowering the operating height of the device to reduce operating potential energy loss are needed. In a group of examples of reducing foundation potential energy loss, one or more steps of preprocessing, decarbonization absorption, neutralization, etc. are carried out on the CCS ocean platform 2.1. Due to the design that CCS ocean platform 2.1 is close to the sea surface, the apparatus installed on it has a significantly lower elevation than the foundation installed inside the onshore power station area in the example.

In a group of examples of reducing potential energy loss, the height of the horizontal centerline of the water distributor of the decarbonization tower is not higher than 50 m, 30 m, 25 m, 20 m, 15 m, 10 m, 9 m, 8 m, 7 m, 6 m, 5 m, 4 m, 3 m, 2 m, 1 m, or 0.5 m relative to the actual sea level. In another group of examples of reducing potential energy loss, the height of the liquid surface in the neutralizer is not higher than 10 m, 9 m, 8 m, 7 m, 6 m, 5 m, 4 m, 3 m, 2 m, 1 m, 0.5 m, or 0.2 m relative to the actual sea level.

In the step that the seawater for decarbonization is drawn from a deep location in the ocean, the purpose is to draw deeper and lower-temperature seawater for decarbonization to achieve higher carbon capture rate. For every 100 m increase in depth in some sea areas, the water temperature decreases by about 0.5° C., which greatly helps to improve CO₂ solubility and carbon capture rate, while the cost increases very little because the power consumption of the water pump is sensitive to the pumping height and not sensitive to the depth of drawing water. For this purpose, in a group of examples, seawater is drawn at a depth of not less than 0.5 m, or not less than 1 m, or not less than 3 m, or not less than 5 m, or not less than 10 m, or not less than 15 m, or not less than 20 m, or not less than 30 m, or not less than 50 m, or not less than 100 m, or not less than 200 m, or not less than 300 m, or not less than 500 m, or not less than 1000 m, or not less than 2000 m below actual sea level.

The power, which is needed for the seawater pump for pumping the seawater for decarbonization and/or neutralizing seawater and/or scrubbing seawater of preprocessing from the ocean, is provided by a carbon-free power generation system 4 in a group of examples. The system can use the carbon-free energy such as wind energy, solar energy, wave energy, tidal energy, nuclear energy, etc. and have no carbon emissions. The system can use energy storage to ensure uninterrupted power supply. The power is provided by the fossil energy system 1 in another group of examples, and is provided by the combination of a carbon-free power generation system 4 and a fossil energy system 1 in another group of examples.

### Example 4

This is basic example of the carbon capture and storage (CCS) system for carrying out the process of the present invention, including:
a preprocessor, which is used to cool and/or desulfurize the flue gas of fossil fuel to generate after-preprocessing flue gas;
a decarbonization tower, which is used to scrub the after-preprocessing flue gas with seawater for decarbonization to absorb and capture carbon dioxide, generating after-decarbonization seawater and decarbonized gas, and discharge the decarbonized gas into atmosphere;
an apparatus for providing seawater for decarbonization, which is used to pump seawater from the ocean into the decarbonization tower, which is used as the seawater for decarbonization;
a discharging apparatus, which is used to discharge the after-decarbonization seawater into an ocean for carbon storage.

The preprocessor, decarbonization tower and discharging apparatus are running at normal pressure (atmospheric pressure), and the water discharging is performed in a mode that the water flows into the next place and/or into the ocean by its own weight.

### Example 5

This is a device example for carrying out the process of the present invention, as shown in FIG. 1-FIG. 6.

The device includes a fossil energy system 1, a CCS system 2, a carbon-free power generation system 4 and a direct air carbon capture and storage (DACCS) system 5 which are provided when near zero or net zero carbon emissions are needed. The fossil energy system 1 includes a combustion device 1.1, a fossil energy converting device 1.5, fossil energy power generation device 1.6, and a channel for outputting clean energy product 1.7 is used to deliver clean energy product to the outside, and a flue gas exhaust duct 1.2 is used to discharge carbon-containing high-temperature flue gas. The CCS system 2 includes a CCS ocean platform 2.1 for bearing CCS equipments, an offshore flue 2.2 for connecting fossil energy system 1 and CCS system 2, and a preprocessor 2.3 for processing the carbon-containing high-temperature flue gas into low-temperature low-sulfur carbon-containing gas. The decarbonization tower 2.12 is installed on the CCS ocean platform 2.1, which is used for the fully contact between the low-temperature low-sulfur carbon-containing gas and seawater for decarbonization for carbon capture of seawater absorption. The apparatus for providing seawater for decarbonization includes a pump of seawater for decarbonization 2.13, a water drawing pipe of seawater for decarbonization pump 2.14, a pipe for delivering seawater for decarbonization 2.16, etc. The apparatus for providing neutralizing seawater includes a neutralizing seawater pump 2.19, a water drawing pipe of neutralizing seawater pump 2.20, a neutralizing seawater pipe 2.22, etc. The pump of seawater for decarbonization 2.13 is used to provide seawater for decarbonization for the decarbonization tower 2.12. The neutralizer 2.18 is installed on the CCS ocean platform 2.1, which is used for mixture and neutralization between the after-decarbonization seawater, which is discharged from the decarbonization tower 2.12, and the neutralizing seawater, which is provided by the neutralizing seawater pump 2.19, to generate the discharging seawater which meets the standard allowed by regulations. The discharging seawater which meets the standard flows into the ocean below the sea level by its own weight through a pipe for discharging seawater which meets the standard 2.26, in order to achieve ocean carbon storage of bicarbonate ion. A discharge pH detecting controller 2.23 (discharge detecting device) is used to detect and control the pH value of the discharging seawater which meets the standard. A CO₂e metering unit/device 3 (apparatus for measuring the amount of carbon capture and storage) is used to measure and calculate the amount of carbon dioxide (CO₂e), which is captured in seawater absorption and stored in the ocean storage of bicarbonate ion. An exhaust pipe 2.25 is used for the communication between the decarbonization tower 2.12 and the atmosphere, allowing the decarbonized gas to be discharged into the atmosphere. A carbon-free power generation system 4 and/or a fossil energy power generation device 1.6 are used to provide power for the CCS system 2. The carbon-free power generation system 4 delivers carbon-free energy product to the outside through a channel for outputting carbon-free energy product 4.7 as needed. The direct air carbon capture and storage (DACCS) system 5 is used to directly capture and store carbon dioxide from the air.

### Example 6

These are multiple groups of examples based on Example 3, as shown in FIG. 1-FIG. 6.

In a group of examples, the combustion device 1.1 includes a boiler, or a combined cycle gas steam turbine (CCGT), or a waste heat boiler, or an internal combustion engine.

In multiple groups of examples of CCS ocean platform for reducing seawater pumping height, the CCS ocean platform 2.1 is a CCS fixed ocean platform 2.1-1, or a CCS height-adjustable ocean platform 2.1-2, or a CCS floating ocean platform 2.1-3, also known as CCS floating dock.

In a group of examples, the CCS fixed ocean platform 2.1-1 is selected. The underwater part is fixed to the seabed through a support frame, and the height of the above water part is fixed. The height of the installed decarbonization tower 2.12, neutralizer 2.18 and preprocessor 2.3 is designed according to the highest tide level. The highest tide level is based on every year, or every 5 years, or every 10 years, or every 50 years, respectively. The example of the design based on the highest tide level of every year is more cost-effective.

Regarding the water related apparatus which has a fixed altitude, the pumping height of needs to be designed according to the highest tide level, which will cause potential energy loss of pumping seawater at low tide. The difference between high and low tides in the same sea area, also known as the tidal range, varies with time and is generally a few meters. In situations where a large amount of water is pumped for CCS, even a tidal range of 0.5 m or 1 m can cause significant power loss.

In a group of examples of reducing power loss caused by tidal range, a CCS height-adjustable ocean platform 2.1-2 is used. As shown in FIG. 3, the ocean platform 2.1 is fixedly connected to the upper end of the support frame of ocean platform 2.15, and the height of the ocean platform 2.1 is adjusted by the support frame of ocean platform 2.15. The lower end of the support frame 2.15 is fixed to the seabed, equipped with hydraulic/pneumatic/mechanical devices to adjust the height, and automatically controls the height of CCS ocean platform 2.1 according to the tide.

In another group of examples of reducing power loss caused by tidal range, a CCS floating ocean platform is used. As shown in FIG. 3, the ocean platform 2.1 is a CCS floating dock 2.1-3 floating on the ocean surface, rising and falling with the tide. In one example, the connection between the floating dock 2.1-3 and the upper part of the support frame of ocean platform 2.15, which is fixed to the seabed, is in a mode of vertical sliding and horizontal restriction. In another example, the CCS floating dock 2.1-3 is equipped with a limiting and anchoring device to limit the horizontal movement range of the ocean platform from being pushed by wind and waves. The limiting and anchoring device is selected from existing marine engineering equipments, such as the barge series. In another example, a conventional ocean vessel is used as the CCS ocean platform. In another example, a self-sustaining floating ocean platform is used as the CCS ocean platform.

In a group of examples, the energy product, which is transmitted to the outside through the channel for outputting clean energy product 1.7, and/or the carbon-free energy product, which is transmitted to the outside through the channel for outputting carbon-free energy product 4.7, are electrical energy, or thermal energy, or mechanical energy, or hydrogen energy, or other energy products.

In a group of examples, the preprocessor 2.3 is installed on the same CCS ocean platform 2.1 with the decarbonization tower 2.12, or is installed onshore with the fossil energy system 1. In a group of examples, the carbon-free power generation system 4 is installed integratedly on the same CCS ocean platform 2.1 with the CCS system 2, and/or is installed offshore and/or onshore adjacent to the CCS system 2.

The seawater for decarbonization is introduced from the upper part outside the decarbonization tower, and is dispersed along the cross-section of the decarbonization tower by a water distributor inside the tower and drops downwards by gravity. It flows through a packing layer in the tower and make contact with the carbon-containing gas in a mode of large area contact to dissolve and capture CO₂. The decarbonization tower includes packings to increase the contact area between atmospheric and liquid. The packings are made of materials that can withstand accident-related high temperatures, including metals, ceramics, and polymer materials.

The offshore flue 2.2 is connected to the onshore combustion device 1.1, so that the carbon-containing high-temperature flue gas is introduced into the CCS ocean platform for preprocessing, or the after-preprocessing flue gas from onshore fossil fuel combustion is introduced into the CCS ocean platform for further processing such as decarbonization absorption.

The offshore flue 2.2 is made of metal and/or polymer and/or other materials, and the expansion length and bending angle can be changed within a large range to adapt to the fluctuation of the CCS ocean platform with the tide and the waves on the sea surface, always maintaining the flue gas transportation between the onshore combustion facilities and the CCS ocean platform. If the CCS ocean platform 2.1 is far from the shore, intermediate support is provided for the offshore flue 2.2, and the support is composed of a support frame fixed on the seabed, and/or floating bridges and/or barges.

The temperature of the seawater for decarbonization, when used for absorption, does not exceed the temperature of the natural temperature of the seawater where the seawater for decarbonization is drawn by more than 5° C., or 4° C., or 3° C., or 2° C., or 1° C. The neutralizing seawater, when used for neutralization, does not exceed the temperature of the natural temperature of the seawater where the neutralizing seawater is drawn by more than 5° C., or 3° C., or 1° C.

The lower outlet of the pipe for discharging seawater which meets the standard 2.26 is located at a depth below sea level, which is not less than 0.5 m, or not less than 1 m, or not less than 3 m, or not less than 5 m, or not less than 10 m, or not less than 15 m, or not less than 20 m, or not less than 30 m, or not less than 50 m, or not less than 100 m, or not less than 200 m, or not less than 300 m, or not less than 500 m.

### Example 7

This is an example of blue carbon power station of the process and system of the present invention, as shown in FIG. 1-FIG. 6.

The power station includes a fossil energy system 1, a CCS system 2, a CO₂e metering unit 3, a carbon-free power generation system 4 and a direct air carbon capture and storage (DACCS) system 5 which are provided for near zero/net zero carbon emissions as needed. The fossil energy system 1 uses a conventional power generation process of coal-fired boiler steam turbine, or a power generation process of gas turbine, and a power generation process of combined cycle gas steam turbine (CCGT) in one group of examples. The combustion of fossil fuel generates thermal energy to drive the steam turbine and generator to generate electricity, while also producing carbon-containing high-temperature flue gas. The CCS system 2 includes a preprocessor 2.3, a decarbonization tower 2.12 and a neutralizer 2.18. Seawater is pumped from the ocean for carbon capture of scrubbing and absorption to the flue gas, and for ocean carbon storage of bicarbonate ion which meets the regulations. The CO₂e measuring unit 3 measures and calculates the amount of carbon dioxide which is captured and stored in the ocean.

In one example, the power station is a low carbon emissions power station, with a carbon capture and storage rate of over 70%, i.e. decarbonization depth. The preprocessor 2.3 is installed onshore, and the cooling seawater at the end of the power station turbine is used as the scrubbing seawater for preprocessing. The preprocessing seawater pump 2.4 is also the cooling water seawater pump in the power station (commonly known as a circulating water pump). The scrubbing seawater for preprocessing is used to process the high-temperature flue gas, and then is processed in a processing pool of preprocessing seawater 2.8 to meet the regulatory discharge standard before being discharged into the ocean. The CCS ocean platform 2.1, where the decarbonization tower 2.12 and the neutralizer 2.18 are installed, is a fixed ocean platform. The seawater, which is required by the decarbonization tower 2.12 and the neutralizer 2.18, is pumped in a mode of large amount and low height, and the required electrical energy comes from the electricity used by the fossil energy power station itself.

In a group of examples, the power station is a near zero carbon emissions power station, with a carbon capture and storage rate of decarbonization depth >90%. The CCS ocean platform 2.1, where the preprocessor 2.3, the decarbonization tower 2.12 and the neutralizer 2.18 are installed, is a height-adjustable CCS ocean platform, which has an adjustable height. The seawater, which is required for the preprocessor 2.3, the decarbonization tower 2.12 and the neutralizer 2.18, is pumped from the ocean in a mode of large volume and low height. The required electricity mainly comes from the carbon-free power generation system 4. The seawater for decarbonization, which is required by the decarbonization tower 2.12, is pumped from the ocean, which is pumped from a depth of not less than 0.5 m, or not less than 1 m, or not less than 3 m, or not less than 5 m, or not less than 10 m, or not less than 15 m, or not less than 20 m, or not less than 30 m, or not less than 50 m, or not less than 100 m, or not less than 200 m, or not less than 300 m, or not less than 500 m, or not less than 1000 m, or not less than 2000 m below the actual sea level. The scrubbing seawater from the preprocessor, which meets the standard, is discharged directly into the ocean.

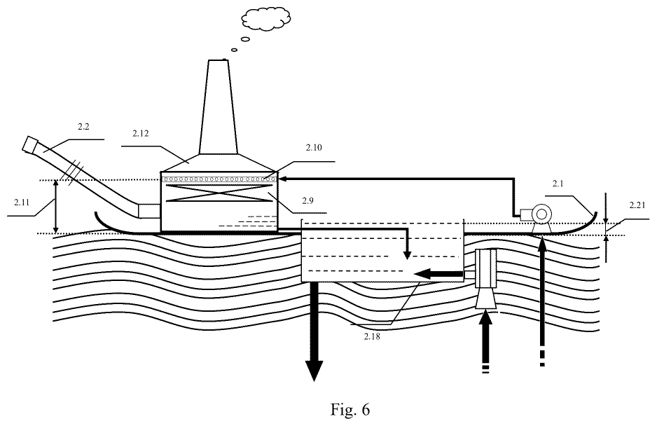

In another group of examples, the power station is a net zero carbon emissions power station, as shown in FIG. 5. The carbon capture and storage rate, i.e. decarbonization depth, is about 100%. The CCS ocean platform 2.1, where the preprocessor 2.3, the decarbonization tower 2.12 and the neutralizer 2.18 are installed, is a CCS floating dock. The seawater, which is required for the preprocessor 2.3, the decarbonization tower 2.12 and the neutralizer 2.18, is pumped in a mode of large volume and low height. The required electrical energy comes from the carbon-free power generation system 4. The decarbonization tower 2.12 captures not less than 95%, or not less than 90%, or not less than 85%, or not less than 80%, or not less than 75%, or not less than 70%, or not less than 60%, or not less than 50% of the CO₂ from the carbon-containing flue gas of fossil fuels in the power station. The amount of CO₂, which is captured and stored directly by the direct air carbon capture and storage (DACCS) system 5 from the atmosphere, is equal to the amount of CO₂, which remains in the decarbonized gas after decarbonization absorption and capture and is discharged into the atmosphere. The required electricity comes from the carbon-free power generation system 4.

In another example, the fossil energy system 1 includes a flue gas bypass system, comprising a flue gas bypass gate 1.3 and a flue gas bypass exhaust pipe 1.4. The flue gas bypass gate 1.3 is installed between the onshore fossil fuel combustion device 1 and the inlet of the offshore flue 2.2. It is used to introduce the fossil fuel flue gas to the flue gas bypass exhaust pipe 1.4 when a risk accident occurs in the CCS process system floating on the sea surface, in order to disconnect the CCS process system, isolate the risk of marine accidents, and ensure the safe running of the onshore fossil energy system.

### Example 8

This is a group of examples of low-carbon transition from the coastal coal-fired power station group to blue carbon power station, as shown in FIG. 1-FIG. 5. The power station group is a original coal-fired power station group running in the existing power grid, with a total installed capacity of 5.28 GW, including 8 sets of 660 MW ultra supercritical generator units. The total CO₂ emissions of the coal-fired boilers in the power station are about 20 Mt/yr, and the exhaust gas temperature is about 128° C. The volume content of SO₂ in the flue gas varies from 300 to 800 ppm depending on the coal quality, and volume of CO₂ is about 13-15% of the volume of flue gas. Eight sets of limestone/gypsum wet desulfurization apparatuses are used for the original flue gas desulfurization (FGD). The evaporation capacity of a single boiler is 2,078 t/h, and the flue gas volume of a single boiler is 1,900,000 Nm³/h. The zero-meter level of the power station has an altitude of 30 m.

The first example is one of retrofit of device for using fossil fuel to produce energy with low carbon emissions. The retrofit process includes the following steps. 1) The original limestone/gypsum wet flue gas desulfurization (FGD) system of the power station is used as the preprocessor 2.3 to process the power station's flue gas into a CO₂-containing gas stream with a temperature of about 60° C. and a SO₂ concentration of less than 80 ppm. 2) The original FGD flue gas bypass gate of the power station is restructured to a flue gas bypass gate 1.3 that matches the process of the present invention, and the original exhaust pipe of the power station is restructured to a flue gas bypass exhaust pipe 1.4 that matches the process of the present invention. 3) The fixed CCS ocean platform 2.1 is built and tested offline, and decarbonization tower 2.12, neutralizer 2.18, offshore flue 2.2 and other CCS process facilities are built on it. The “offline” refers that the building, installing and testing before connection do not affect the running of the onshore power station at all. 4) During the planned maintenance and shutdown period of the power station, the CCS ocean platform 2.1 and the CCS system is connected, and/or the existing flue gas bypass gate 1.3 is used for switch to the CCS system without shutting down the power station. The power required for the CCS system is provided by the plant electricity of the power station. After implementation, the coal-fired power station will achieve low carbon emissions, with a carbon capture and storage rate greater than 75% and a total CCS capacity of 15 Mt/yr.

The second example is based on the first example. It is an example of retrofit of device for using fossil fuel to produce energy with near zero carbon emissions. The retrofit process includes the following step. 1) A special preprocessor 2.3 of seawater scrubbing mode is installed on the CCS height-adjustable ocean platform 2.1-2. Fresh seawater nearby is drawn and used as the scrubbing seawater for preprocessing on the CCS ocean platform 2.1. Therefore, the flue gas temperature after preprocessing is significantly reduced compared to the one in the first example. 2) A pump of seawater for decarbonization 2.13 is installed on the height-adjustable CCS ocean platform 2.1-2, and the lower end of the water drawing pipe of pump of seawater for decarbonization 2.14 is located at a depth of 300 m below the sea level, allowing decarbonization absorption to occur under lower temperature conditions, resulting in an increase in carbon capture rate and a decrease in power consumption. 3) A new wind and/or photovoltaic power station near the power station is built as a carbon-free energy generation system, providing all the required electricity to the CCS system, so that the entire process of carbon capture and storage does not consume fossil energy electricity and achieves zero carbon footprint. After implementation, the coal-fired power station achieved near zero carbon emissions, with a carbon capture and storage rate of 95% and a total CCS of 19 Mt/yr.

The overall effects of this example are as follows.

1) The original FGD process system is shut down and dismantled. Each year it consumed hundreds of thousands of tons of ore (desulfurizer) from mining areas, which are hundreds of kilometers away. Each year it also consumed millions of tons of fresh water (desulfurizer solvent) from seawater desalination. A large amount of carbon emissions were generated in these energy resource consumption processes. Their economic costs are reduced to zero.

2) The total cost after adding deep decarbonization in this example is close to the running cost of the original FGD. Therefore, the increase of the total cost of power generation after adding deep decarbonization function to the power station is very little, or is even none.

3) All captured CO₂ is converted into bicarbonate ions, the natural form of carbon in seawater, and permanently stored in the carbon sink of marine ecosystems. This not only complies with current international conventions and national regulations, but also ensures a friendly marine ecological environment.

### Example 9

This is another group of examples of low carbon transition of a coastal coal power station group, as shown in FIG. 1-FIG. 5. The power station group is a coal-fired power station group running in the existing power grid, with a total installed capacity of 5.28 GW, including 8 sets of 660 MW ultra supercritical power generation units. The total CO₂ emissions from the coal-fired boilers of the power station are about 20 Mt/yr, and the flue gas temperature is about 128° C. The volume content of SO₂ in the exhaust gas varies from 300 to 800 ppm depending on the coal quality, and the volume of CO₂ is about 13-15% of the volume of the flue gas. The original flue gas desulfurization (FGD) system consists of 8 sets of seawater desulfurization equipments, using cooling water from power station steam turbines as the scrubbing desulfurizer for the desulfurization process. The evaporation capacity of a single boiler is 2,075 t/h, and the flue gas volume of a single boiler is 1,905,000 Nm³/h. The zero meter level of the power station has an elevation of 33 m.

The first example is one of retrofit of device for using fossil fuel to produce energy with low carbon emissions. The implementation process includes the following steps. 1) The original seawater flue gas desulfurization (FGD) system of the power station is used as the preprocessor 2.3 to process the flue gas of the power station into a CO₂-containing gas stream with a temperature of about 40° C. and a SO₂ concentration of less than 80 ppm. Steps 2), 3) and 4) are the same as steps 2), 3) and 4) of the first implementation process in Example 6. After implementation, the coal-fired power station achieves low carbon emissions, and the carbon capture and storage rate is greater than 80%, and a total CCS capacity is approximately 16 Mt/yr.

The second example is one of retrofit of device for using fossil fuel to produce energy with near zero emissions. The retrofit process is basically the same as the implementation process of the second example of Example 6, and the effect after implementation is also basically the same. The coal-fired power station achieves nearly zero carbon emissions, with a carbon capture and storage rate of 95% and a total CCS of 19 Mt/yr.

The third example is one of retrofit of device for using fossil fuel to produce energy with net zero carbon emissions. Based on the second example, an ocean-based direct air carbon capture and storage (DACCS) system is added. All the electricity required for this new DACCS system and the original CCS system will be supplied by carbon-free power generation systems such as a wind power station and/or a photovoltaic power station. After implementation, the overall coal-fired power station achieves net zero carbon emissions, with a flue gas carbon capture and storage rate of 95%, a total CCS of 19 Mt/yr, and a total DACCS of 1 Mt/yr, equivalent to the remaining amount after carbon capture and storage. The total carbon reduction of CCS+DACCS is 20 Mt/yr, which is equivalent to the CO₂ production of the coal-fired power station at 20 Mt/yr.

All newly added CCS and/or DACCS facilities are located offshore, which solves the problem of the lack of space for CCS facilities in existing coastal power station.

### Example 10

This is an example of low carbon transition of a coastal gas power station. The fuel for the coastal gas power station is liquefied natural gas (LNG). Three sets of gas steam combined cycle generator units are set. Each unit is 400 MW, and the total installed capacity is 1200 MW. The flue gas temperature of the waste heat boiler is about 85-100° C. The SO₂ content is low and desulfurization is not required. The flue gas contains about 7% CO₂. The process of this example comprises the following steps. 1) A flue gas bypass gate 1.3, which is needed in the process of the present invention, is installed on the exhaust duct of the waste heat boiler of the power station, and the original exhaust pipe of the power station is replaced by a flue gas bypass exhaust pipe 1.4, which is needed in the process of the present invention. 2) A CCS ocean platform 2.1 is built offline and tested offline. The ocean platform is a CCS floating dock 2.1-3. A preprocessor 2.3 of seawater scrubbing is built on top of it to process the high-temperature CO₂-containing flue gas, which is discharged by the power station, into a CO₂-containing gas stream with a temperature of about 30° C. CCS facilities such as decarbonization tower 2.12, neutralizer 2.18, and offshore flue 2.2 are provided. 3) During the maintenance and shutdown period of the power station, the CCS floating dock and the CCS system is connected, and/or the flue gas bypass gate 1.3, which has been built, is used for the connecting to the CCS system without shutting down the power station. The power for the CCS system is provided by the plant electricity of the power station. After implementation, the gas power station will achieve near zero carbon emissions, with a carbon capture and storage rate greater than 95%.

The combined cycle gas steam process, which is a typical example of natural gas power station, has half the carbon emissions of coal-fired power station, but their total scale is not small and they continues to expand, with a greater impact on global carbon emissions than coal-fired power station. The technical solution of the present invention has great significance for achieving low carbon transition of gas power stations and achieving climate goal.

The scope of protection of the claims of the present invention is not limited to the above-mentioned examples.

1. A process for using fossil fuel to produce energy with net zero carbon emissions, comprising the steps of:
1) burning fossil fuel to generate energy and flue gas;
2) performing preprocessing of cooling and/or desulfurization to the flue gas to generate after-preprocessing flue gas;
3) using seawater for decarbonization to absorb and capture carbon dioxide from the after-preprocessing flue gas to generate after-decarbonization seawater and decarbonized gas;
4) discharging the decarbonized gas into atmosphere;
5) discharging the after-decarbonization seawater into an ocean for carbon storage.

2. The process according to claim 1, wherein the temperature of the after-preprocessing flue gas does not exceed the temperature of the seawater for decarbonization by more than 50° C., 30° C., 20° C., 10° C., or 5° C., and the volume content of SO₂ in the after-preprocessing flue gas is less than 100 ppm, or 80 ppm, or 30 ppm.

3. The process according to claim 1, wherein the process further comprises a step of providing a CCS ocean platform, and the scrubbing is performed on the CCS ocean platform to reduce the height and power consumption of pumping the seawater for decarbonization.

4. The process according to claim 1, wherein in step 5), the after-decarbonization seawater is mixed with neutralizing seawater to form a mixed seawater before discharged into the ocean, to raise the pH value to meet the legal discharge standard, so that the CO₂, which is absorbed and captured by the seawater, is converted into bicarbonate ions (HCO₃⁻) and discharged into the ocean to achieve ionic ocean carbon storage.

5. The process according to claim 1, wherein the process further comprises a step of measuring and calculating the amount of carbon dioxide (CO₂e), which is absorbed and captured from the flue gas, through measuring and calculating the difference between the CO₂ content in the flue gas and the CO₂ content in the decarbonized gas, and the CO₂e measurement data is transmitted in real-time or periodically to a carbon accounting system.

6. The process according to claim 1, wherein the process further comprises a step of providing a carbon-free power generation system and/or a direct air carbon capture and storage (DACCS) system.

7. A carbon capture and storage (CCS) system for using fossil fuel to produce energy with net zero carbon emissions, including:
a preprocessor, which is used to cool and/or desulfurize the flue gas of fossil fuel to generate after-preprocessing flue gas;
an decarbonization tower, which is used to scrub the after-preprocessing flue gas with seawater for decarbonization to absorb and capture carbon dioxide, generating after-decarbonization seawater and decarbonized gas, and discharge the decarbonized gas into atmosphere;
an apparatus for providing seawater for decarbonization, which is used to pump seawater from the ocean into the decarbonization tower, which is used as the seawater for decarbonization;
a discharging apparatus, which is used to discharge the after-decarbonization seawater into an ocean for carbon storage.

8. The system according to claim 7, wherein a carbon-free power generation system is used to provide the energy to pump the seawater for decarbonization from the ocean; and the carbon-free energy comprises one or more of wind energy, solar energy, wave energy, tidal energy and nuclear energy; and the carbon-free power generation system includes an energy storing device to ensure uninterrupted power supply.

9. The system according to claim 7, wherein the preprocessor is configured to use preprocessing seawater to scrub the flue gas to perform preprocessing of cooling and/or desulfurization.

10. The system according to claim 7, wherein SO₂ volume content in the after-preprocessing flue gas is less than 100 ppm, or less than 80 ppm, or less than 30 ppm.

11. The system according to claim 7, wherein the temperature of the after-preprocessing flue gas does not exceed the temperature of the seawater for decarbonization by more than 50° C., or 30° C., or 20° C., or 10° C., or 5° C.

12. The system according to claim 7, wherein the discharging apparatus further includes a neutralizer, which is used to mix the after-seawater for decarbonization with neutralizing seawater to form mixed seawater, so as to increase the pH value to meet the legal discharge standard.

13. The system according to claim 7, wherein the system further includes a CCS ocean platform, and the preprocessor and/or the decarbonization tower and/or the neutralizer are located on the CCS ocean platform to reduce the height and power consumption of pumping seawater.

14. A blue carbon power station, comprising a fossil energy system for burning fossil fuel to generate electricity and flue gas, wherein the blue carbon power station further comprises a CCS (carbon capture and storage) system of claim 7, which is used to decarbonize the flue gas.

15. The blue carbon power station according to claim 14, wherein the CCS system further comprises a neutralizer, a CCS ocean platform and a carbon-free power generation unit; wherein the preprocessor, the decarbonization tower and the neutralizer are located on the CCS ocean platform; and the CCS ocean platform is a floating and/or height-adjustable ocean platform that can rise and fall with the tide; and the preprocessor is used to scrub the flue gas with preprocessing seawater to perform preprocessing of cooling and/or desulfurization; and the preprocessing seawater, the seawater for decarbonization and the neutralizing seawater are drawn from the ocean and the energy for pumping seawater is provided by a carbon-free power generation system and/or the power station itself; and at least 95%, or 90%, or 85%, or 80%, or 75%, or 70%, or 60%, or 50% of carbon dioxide in the flue gas is captured and stored; and the CCS system further includes a direct air carbon capture and storage (DACCS) system, which is used to directly capture and store carbon dioxide from the atmosphere, and the amount of carbon dioxide, which is captured and stored, is equal to the amount of carbon dioxide in the decarbonized gas, which is discharged into the atmosphere.
